(19) United States
(12) Patent Application Publication
(10) Pub. No.: US 2005/0172548 A1
(43) Pub. Date: Aug. 11, 2005

(54) Frost protection for plants

(76) Inventor: Ronald A. Bement, Houston, TX (US)

Correspondence Address: SHAWN HUNTER, P.O Box 270110, HOUSTON, TX, 77277-0110, US

(21) Appl. No.: 10/774,850

(22) Filed: Feb. 9, 2004

(51) Int. Cl. A01G 13/04

(52) U.S. Cl. 47/23.1

(57) ABSTRACT

Frost covers are described that define an enclosure for an individual plant or group of plants to protect the sides and lower portions of the plants as well as their tops from frost damage. Each cover is shaped to envelop a single plant or group of plants and is provided with a retaining mechanism, such as an elastic band or drawstring, which allows the frost cover to be secured to the plant or group of plants against winds. The covers are inexpensive, reusable, disposable, and may be formed into a variety of shapes and sizes to accommodate a wide variety of sizes of plants and groups of plants. The frost covers are fashioned from a semi-transparent, air-permeable and moisture permeable membrane that permits some sunlight and water to pass through the membrane while causing frost to form atop the membrane rather than on the covered plant.

### BACKGROUND OF THE INVENTION

1. Field of the Invention

The invention relates generally to frost covers for plants and the like.

2. Description of the Related Art

Freezing conditions can occur with little warning and, in many parts of the country, can continue for long periods of time. Many small trees, shrubs, and garden plants are highly susceptible to damage from frost, even if exposed to frost and freezing conditions for a short time. There are no acceptable commercial products for frost protection for such plants that are compact, reusable, disposable and inexpensive.

Typically, when a frost warning is issued, homeowners place towels, sheets and other similar tarps over the plants in the evening. However, these measures do not provide optimal protection and are problematic for long term use. These objects do not permit light to pass through to plants. They also get wet from melted frost and weigh down the plants, possibly harming the plants and necessitating at least a load of laundry. Clear plastic sheeting would allow light to reach the plants, but does not permit the plants to breathe sufficiently and is, therefore, unsuitable for long-term use. Another downside to using plastic sheeting and the like is that it will tend to adhere and freeze to anything that it comes into contact with, thus transmitting the outside air temperature and freezing process directly along to the leaves, stalks and other portions of the plants that are intended to be protected by the sheeting.

Additionally, planar tarps, such as household bedsheets, do not protect the sides and lower portions of plants from frost damage. Frost may appear on lower, uncovered branches and damage those portions of the plants. Further, such planar tarps may easily blow off in windy weather, leaving the plants uncovered. A better solution would be desirable.

There are some specialized planar covers that are known and used for protection of plants, primarily in the field of large-scale crop protection. Unfortunately, these products are not particularly useful for residential or small-scale commercial usage. U.S. Pat. No. 5,076,008 issued to Arroyo describes a horticultural fabric cover that is superabsorbant. The fabric cover is made up of a substrate of spunbonded non-woven polypropylene material, such as REEMAY®, and a layer of superabsorbant material. Because of the presence of the superabsorbant material, this horticultural fabric is generally unsuitable for residential or small-scale commercial usage over any length of time. Melting frost would be absorbed into the superabsorbant layer, making the fabric cover quite heavy and, thereby, potentially damaging to the plants that it covers. Additionally, absorption of water into the fabric cover will render it essentially unusable afterward. Also, this fabric cover is supplied to a plant grower in the form of a roll, and is therefore, prone to many of the same disadvantages as other planar covers.

A number of other protective structures are also known in the prior art for use in frost protection. However, most of these utilize a frame or support structure that is intended to keep the cover material from contacting the plant. Unfortunately, these protective structures are typically bulky to store and difficult to clean. Examples of this type of protector are described in U.S. Pat. No. 4,347,685 issued to Medford et al. and U.S. Pat. No. 4,829,707 issued to Koffler et al.

The present invention is directed to overcoming the problems of the prior art.

### SUMMARY OF THE INVENTION

The present invention provides an improved device and method for protection of individual plants and groups of plants from frost, freezing and the like. Exemplary frost covers are described that define an enclosure for an individual plant or group of plants to protect the sides and lower portions of the plants as well as their tops from frost damage. Each cover is shaped to envelop a single plant or group of plants and is provided with a retaining mechanism, such as an elastic band or drawstring, which allows the frost cover to be secured to the plant or group of plants against winds. The covers are inexpensive, reusable, disposable, and may be formed into a variety of shapes and sizes to accommodate a wide variety of sizes of plants and groups of plants.

The frost covers are fashioned from a semi-transparent, air-permeable and moisture permeable membrane. A currently preferred membrane is a non-woven spun-bonded mesh fabric that permits some sunlight and water to pass through the membrane while causing frost to form atop the membrane rather than on the covered plant. Preferred mesh fabrics include spun-bonded polypropylenes and spun-bonded olefins.

In use, the frost cover is placed over a plant or group of plants so that the top and four vertical sides of the plant/group of plants is covered and surrounded by the fabric of the frost cover. The retaining mechanism is then used to secure the frost cover to the plant or group of plants. The frost cover may be easily removed by reversing the process and then either stored for reuse or disposed of. The devices and methods of the present invention provide a number of advantages over conventional devices and methods for frost protection.

### BRIEF DESCRIPTION OF THE DRAWINGS

For detailed understanding of the invention, reference is made to the following detailed description of the preferred embodiments, taken in conjunction with the accompanying drawings in which reference characters designate like or similar elements throughout the several figures of the drawings.

FIG. 1 is an illustration of an exemplary frost cover constructed in accordance with the present invention.

FIG. 2 depicts an exemplary frost cover in place over a single plant.

FIG. 3 depicts an exemplary frost cover in place over a group of plants.

### DETAILED DESCRIPTION OF THE PREFERRED EMBODIMENTS

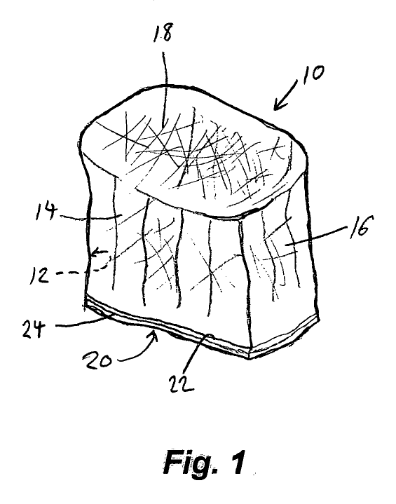

FIG. 1 depicts an exemplary frost cover 10 for a plant or group of plants. The frost cover 10 is formed as a bag or sack to define an interior enclosure 12. The frost cover 10 is fashioned from a spun-bonded mesh fabric of a type known in the art for fluid filtration. One currently preferred mesh membrane for this application is a polypropylene spun-bonded mesh sold under the commercial name REEMAY®. Other suitable mesh membranes are Tyvek®, a spun-bonded olefin material available from DuPont Corporation. However, other meshes and fabrics having the same or similar properties may be used instead. A currently preferred thickness of the mesh membrane is from approximately 6 to approximately 9 mils. The mesh membrane is a semi-transparent, air-permeable and moisture permeable fabric that permits light and water to pass through to a plant beneath. Frost, however, will form and crystallize on the outer surface of the cover 10. As illustrated in FIG. 1, the frost cover 10 provides four side walls (two shown at 14, 16) and an upper wall 18. Although these walls are shown to be separate planar surfaces in FIG. 1, it will be understood that all of the surfaces may be unitarily formed and contiguous in order to form the enclosure 12. The frost cover 10 also includes an open end, or opening, 20. The opening 20 is preferably provided with a seam 22 that contains within a retaining mechanism 24. The retaining mechanism 24 may be an elastic band, a drawstring, or incorporate a Velcro®-style fastener, of a type known in the art.

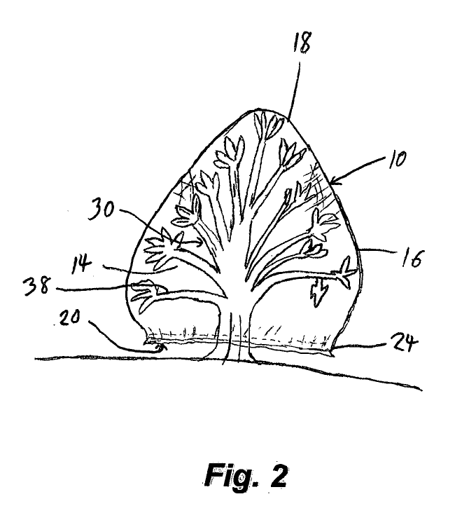

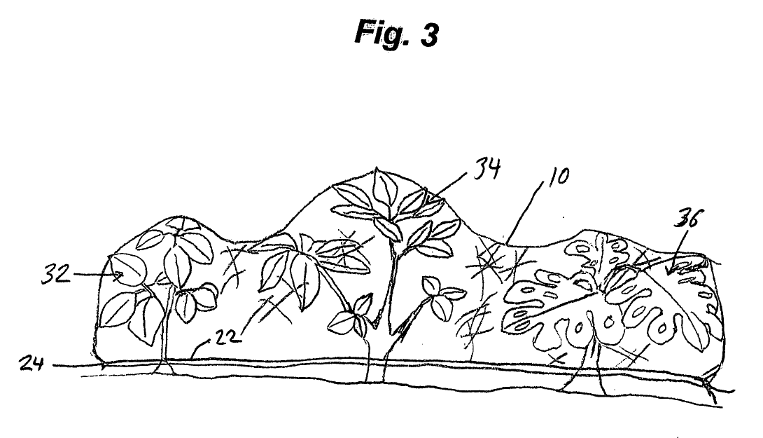

The frost covers 10 may be made in a variety of shapes and sizes, as necessary to accommodate different sizes of plants or groups of plants. FIG. 2 depicts an exemplary frost cover 10 having been emplaced about a single plant 30. FIG. 3 illustrates a frost cover 10 that has been emplaced about a group of plants 32, 34, 36. In each case, the open end 20 of the frost cover 10 is placed over the top of the single plant 30 or group of plants 32, 34, 36 so that the sides 14, 16 lie horizontally adjacent the sides of the plant 30 or group of plants 32, 34, 36. It is noted that even the lower branches (i.e., 38 in FIG. 2) and lower portions of the plants are now protected from frost, unlike when a planar tarp is used, which would rest upon the tops of the plants, but might not provide protection to such lower portions. Further, the frost cover 10 may be, and preferably is, placed in contact with the plants and does not need to be supported above the plants. Then, the frost cover 10 is secured about the plant 30 or group of plants 32, 34, 36 by tightening of the retaining mechanism 24. If the retaining mechanism 24 is an elastic band, the tightening process occurs automatically as the band restricts the opening 20. If the retaining mechanism is a drawstring, the tightening process is done by manually tightening the drawstring to restrict the opening 20. Alternatively, if the retaining mechanism 24 is a hook-and-loop style closure mechanism, such as Velcro®, the tightening process is done by manually fastening this device. Removal of the frost cover 10 is accomplished by reversing the process described above.

The devices and methods of the present invention provide a number of clear advantages over conventional frost protection techniques. Frost covers constructed in accordance with the present invention will prevent frost accumulation on leaves and foliage for essentially any and all types of outdoor plants, shrubbery and vegetation that would be susceptible to damage from it. Additionally, the covers provide for quick and easy installation and removal from such plants. Because the frost cover permits air, water and light to pass through it, the plants may be watered through the frost cover, if desired. Additionally, the frost cover will permit sunlight to reach the plants and for plant respiration to occur through the cover. The frost covers may be removed from the plants following use and, if desired, folded away and reused at a later time. Alternatively, the frost covers may be readily disposed of following a single use. The frost covers are also inexpensive.

Those of skill in the art will recognize that numerous modifications and changes may be made to the exemplary designs and embodiments described herein and that the invention is limited only by the claims that follow and any equivalents thereof.

1. A frost cover for a plant or group of plants, comprising a container formed of a spun-bonded mesh fabric, the container defining an interior enclosure to surround the top and sides of a plant and an opening for emplacement around a plant.

2. The frost cover of claim 1 further comprising a retaining mechanism for tightening the opening.

3. The frost cover of claim 1 wherein the mesh fabric has a thickness of between approximately 6 mils and approximately 9 mils.

4. The frost cover of claim 2 wherein the retaining mechanism comprises an elastic band.

5. The frost cover of claim 2 wherein the retaining mechanism comprises a drawstring.

6. The frost cover of claim 2 wherein the retaining mechanism comprises a Velcro®-style fastener.

7. The frost cover of claim 1 wherein the membrane is formed of polypropylene.

8. The frost cover of claim 1 wherein the membrane is formed of olefin.

9. A frost cover for a plant or group of plants consisting of:
a container formed of a spun-bonded mesh fabric, the container defining an interior enclosure to surround the top and sides of a plant;
an opening to said interior enclosure; and
a retaining mechanism for tightening the opening.

10. The frost cover of claim 9 wherein the retaining mechanism comprises a drawstring.

11. The frost cover of claim 9 wherein the retaining mechanism comprises an elastic band.

12. The frost cover of claim 9 wherein the retaining mechanism comprises a Velcro® fastener.

13. The frost cover of claim 9 wherein the mesh fabric has a thickness of between approximately 6 mils and approximately 9 mils.

14. The frost cover of claim 9 wherein the mesh fabric is comprised substantially of polypropylene.

15. The frost cover of claim 9 wherein the mesh fabric is comprised substantially of olefin.

16-20. (canceled)
